(19) United States
(12) Patent Application Publication
(10) Pub. No.: US 2009/0302789 A1
(43) Pub. Date: Dec. 10, 2009

(54) Method for Identification of the Sensor Assignment within an Electrical Machine

(76) Inventors: Steffan Waldenmeier, Kieselbronn (DE); Klaus Rechberger, Ludwigsburg (DE); Martin Eisenhardt, Renningen (DE)

Correspondence Address: KENYON & KENYON LLP, ONE BROADWAY, NEW YORK, NY, 10004, US

(21) Appl. No.: 12/227,297

(22) PCT Filed: Apr. 2, 2007
(86) PCT No.: PCT/EP2007/053174

§ 371 Date: Jul. 21, 2009

(30) Foreign Application Priority Data
Jun. 2, 2006 (DE) 10 2006 025 906.8

(51) Int. Cl. H02P 6/16

(52) U.S. Cl. 318/400.04

(57) ABSTRACT

A method for identifying the sensor assignment to the output signals of an electrical machine having at least two standardized sensor elements, that are assigned to a rotating body. An arbitrary signal sequence of sensor signals of the at least two standardized sensor elements is recorded for a first direction of rotation of the electrical machine. The arbitrary signal sequence is sorted with respect to the electrical angle φ of the electrical machine corresponding to an offset of the electrical angle φ per sensor signal. The zero crossings of phases of the electrical machine are assigned to the sensor signals.

### BACKGROUND INFORMATION

German Patent Application No. DE 103 03 692 A1 describes a device for recording the rotational speed and the rotational position of a driven shaft. In order to record the rotor position of an electrical machine, a pulse-generating wheel is installed, at whose outer circumference an incremental tooth construction is developed. The teeth and the tooth gaps of the incremental tooth construction are executed in a first tooth division. The scanning is performed using at least one sensor. The incremental tooth construction is executed at the outer circumference in a first tooth pitch that enables a high rotary angle resolution, and at the inner circumference of the pulse-generating wheel, an index tooth construction is provided, using which a number of zero pulses corresponding to the number of machine poles of the electrical machine is able to be generated. The incremental tooth construction is developed to be continuous at the outer circumference of the pulse-generating wheel. A first and a second outer sensor are assigned to the incremental tooth construction at the outer circumference for the detection of the direction of rotation of the electrical machine, whereas a first and a second inner sensor are assigned to the index tooth construction at the inner circumference of the pulse-generating wheel.

Application-specific sensors are used these days for rotational speed detection or rather situation or position detection in electrical synchronous machines. A new construction is required for each application case, as well as the procurement of the respectively specific tools. Among these are plastic injection molding tools, stamping and mounting tools, and also workpiece supports as well as testing devices and more of the like. In current constructions, the sensors are accommodated in a sensor housing, this sensor housing being designed as a direct geometric function of the diameter of a pulse-generating wheel. If the pulse-generating wheel diameter in an electrical machine changes, the sensor housing has to be adapted accordingly. If the reading direction of the sensor system changes based on other installation conditions, an adaptation of the sensor housing is also frequently required.

### SUMMARY

The present invention relates to providing a sensor concept which permits a variable installation of identical sensors within an electrical machine. Furthermore, the present invention relates to providing a software which is able to detect the sensor assignment to the respective phase-shifted output signals, within initial rotations of the electrical machine.

Following the design approach proposed according to example embodiments of the present invention, a standardized sensor element, which is the same for all variants, is connected to a flex foil, a flat flexible cable (FFC) or a cable harness, or the like. At least two sensor elements, for instance, in the path of laser welding, are electrically contacted to this flex foil or this flat flexible cable. Using the sensor system, the position detection of an element or an angle or rotational speed recording is able to take place in the case of any rotating or rotatable objects. If two sensor elements are electrically contacted to the flex foil or to a flat flexible cable (FFC), this sensor system may be used in electrical machines, such as asynchronous machines. However, if three sensor elements are electrically contacted to the flex foil or to the flat flexible cable (FFC), the sensor system obtained may be used in synchronous machines. The standardized sensor elements include sensor electronics which makes possible the use of the standardized sensor element in electrical machines both for asynchronous machines and synchronous machines.

The sensor elements developed in a standardized manner may be combined to form sensor groups having two or three sensor elements. The individual sensor elements developed in a standardized manner of a sensor system including two or more standardized sensor elements are connected to one another by the flexibly developed flex foil or the flat flexible cable (FFC). A separate opening for installation may be assigned to each sensor element that is developed in a standardized manner which, for instance, may be applied at a distance from the sensor head of the standardized sensor elements. Based on the connection of the individual standardized sensor elements via the flex foil or the flat flexible cable (FFC), it is possible to carry out the required resolution independently of the diameter or the circumference of the rotating element that is to be scanned, for instance, in an angular measurement of a rotating component, such as a pulse-generating wheel of an electrical machine or the like, where signal angles of 10° are demanded, for instance. The flex foil or the flat flexible cable (FFC) may be pushed together or pulled further apart depending on the spacing required, because of the standardized sensor elements that are connected to one another via the flex foil or the flat flexible cable (FFC). With that, one is able to use the sensor system proposed, according to the present invention, for different diameters of rotating bodies that are to be scanned with respect to angular recording or rotational speed recording, without changes being required on a sensor housing. The variability of the proposed sensor system comes about due to a simple adaptation of the distance of the individual sensor elements of standardized design relative to one another, so that different purposes of application are easily implemented.

In view of the circumstance that three standardized, identical sensors are able to be installed without taking into account the respective signal assignment, this represents an advantage in mounting the standardized sensor element, on the one hand, and has the effect of optimizing costs based on large piece counts, on the other hand. Furthermore, the assignment of the control unit to an electrical machine is invalid. In a fault case, the sensor system or a single sensor may be exchanged. Plausibilization of a signal takes place at a defined rotational direction and rotational speed over the signal sequence. In addition, the association of the individual signals of the respective individual standardized sensor elements with the respective phase crossover of the electrical machine is possible, so that mechanical installation tolerances can be eliminated. If the electrical machine is used, for instance, together with an internal combustion engine within a hybrid drive or as a generator on an electrical machine, a self-calibration of same takes place after the installation of the standardized sensor elements. The electrical machine cranks the internal combustion engine through, whereby any desired position of an impressed rotating field occurs. From the impressed rotating field there follows the knowledge of the edge angle of the signals having an accuracy of ±10°, with reference to the electrical angle. With that, the angle between a pulse-generating wheel and the rotor magnet of the electrical machine becomes known, taking tolerance influences into account (absolute position offset).

The electrical machine now accelerates the internal combustion engine to a starting speed that is sufficient for a first start of the internal combustion engine. After a successful start of the internal combustion engine, it will rotate by itself, and will drive the electrical machine on its part. At this point, voltages are induced in the electrical machine, based on the torque present because of the internal combustion engine. In this state, there takes place the start of a first search algorithm, within which there takes place a 60° edge assignment. Furthermore, a second search algorithm may be started, with the aid of which an exact absolute position offset may be determined, that is, the exact difference angle between the pulse-generating wheel and the rotor magnet of the electrical machine.

### BRIEF DESCRIPTION OF THE DRAWINGS

Below, the present invention is explained in greater detail based on the figures.

FIG. 1 shows the application of an electrical outgoing cable on the sensor system.

FIG. 2 shows an extrusion coating of the sensor elements at their upper end faces for the encapsulation of the electrical contact location between the flex foil or the flat flexible cable (FFC) or the like and the terminal contacts of the sensor elements.

FIG. 3 shows the signal pattern in response to one rotation of a pulse-generating wheel for an electrical angle and a mechanical angle.

FIG. 4 shows a sensor system according to the present invention in the radial alignment for scanning the circumference of a rotating body, such as a pulse-generating wheel having recesses and elevations.

FIG. 5 shows a signal pattern during “forward travel” having the association of the phases of the electrical machine.

### DETAILED DESCRIPTION OF EXAMPLE EMBODIMENTS

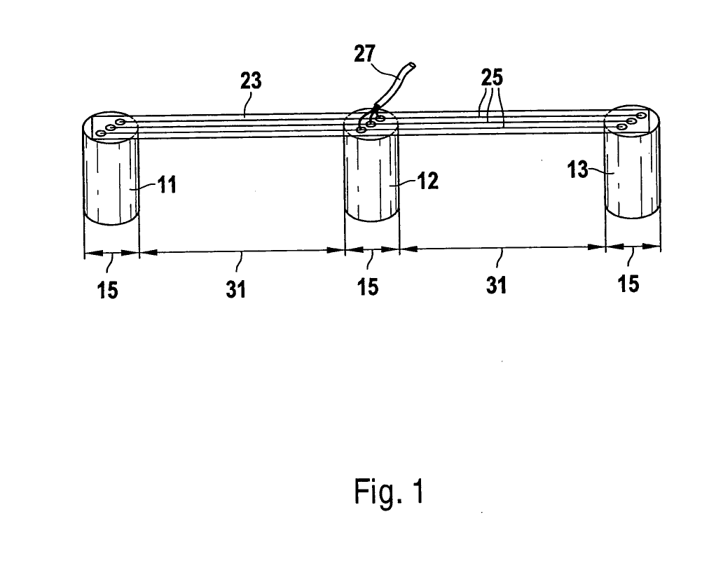

FIG. 1 shows the application of an outgoing cable on the sensor system.

The illustration of FIG. 1 shows that an outgoing cable 27 is, for example, above a second standardized sensor module 12. Instead of outgoing cable 27 being provided in FIG. 1 at second standardized sensor element 12, it could be provided equally well at a first standardized sensor element 11 or at a third standardized sensor element 13. Reference numeral 31 marks a first distance between the individual standardized sensor elements 11 and 12, and 12 and 13. Standardized sensor elements 11, 12 and 13 are positioned, from a mechanical point of view, in such a way that, in response to a mechanical forward rotation of a rotating body, for instance, of a pulse-generating wheel, first of all a first standardized sensor element 11 is passed and lastly, for instance, third standardized sensor element 13 is passed. Distance 31, which is preferably between 40 and 60 mm, for example, 57 mm, is selected so that the sensor system obtained is able to be installed in the housing of the electrical machine at 10°, 20° and 40° arrangements of the sensor system, and as a result, the most different rotating body diameters can be covered. When mounting sensor system 69, the regions of a flex foil 23 or a flat flexible cable (FFC) extending between sensor elements 11, 12 and possibly 13 are either compressed and thus pushed together or drawn apart, corresponding to the spacing setting in between sensor elements 11, 12 or 13.

Using first distance 31 shown in FIG. 1, preferably between 40 mm and 60 mm, thus, for example 57 mm, between individual standardized sensor elements 11 and 12 or 12 and 13, pulse-generating wheel diameters of 80 mm to 300 mm may be covered.

After outgoing cable 27, shown in FIG. 1, provided in the present exemplary embodiment at second standardized sensor element 12, is produced, standardized sensor elements 11, 12 and 13 are extrusion coated with a plastic material in the area of their electrical terminals 17 at an end face 19 and at the part of flex foil 23 covering the end face of standardized sensor elements 11, 12 and 13. Alternatively, flex foil 23 or flat flexible cable (FFC) may be contacted directly to the IC of the respective standardized sensor element 11, 12 or 13 by laser welding, crimping or other suitable method. Such contacting may then also be end-extruded with plastic. The advantages in doing this are, on the one hand, omission of the punched grid and the required connecting technique, which reduces manufacturing costs, and on the other hand, a greater degree of flexibility, in case components are added or the interfaces to the IC change if, for instance, a change is made from a two-wire interface to a three-wire interface. In this context a bordering 41 is created which surrounds the upper part of the cylinder-shaped housing of standardized sensor elements 11, 12 and 13. The electrical connection point between the individual electrical conducting paths 25 that run in flex foil 23, or rather the regions of flat flexible cable (FFC), which run at end face 19 of individual standardized sensor elements 11, 12 and 13, are thus encapsulated and protected from damage. In each of extrusion coatings 29, which surround the upper part of the cylinder-shaped housing of standardized sensor elements 11, 12 and 13, a mounting opening 35 is provided.

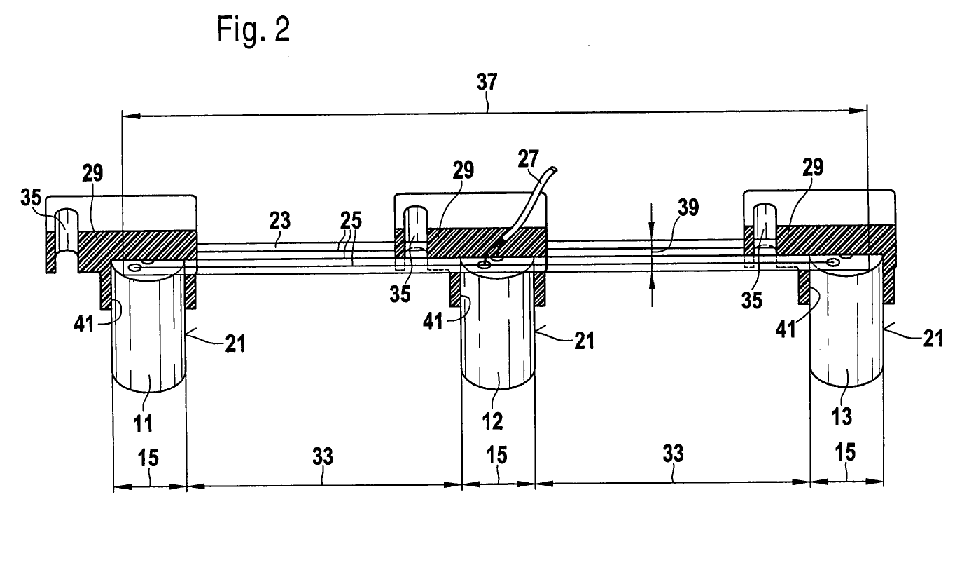

One may see in FIG. 2 that flex foil 23 which includes the individual conductors 25 is designed to be flat. The longitudinal extension of flex foil 23 or of flat flexible cable (FFC), which may be used instead of the planar flex foil 23, is identified by reference numeral 37, while the width of flex foil 23 or of the system of flat flexible cables (FFC) is identified by reference numeral 39. The individual end extrusion coatings 29 are now flexibly connected to one another by the free areas of flex foil 23 or flat flexible cables (FFC), whereby handling during installation is simplified considerably, without impairing the electrical contacts between the individual standardized sensor elements 11, 12 and 13 to one another by flex foil 23. It may be seen in the illustration according to FIG. 2 that standardized sensor elements 11, 12 and 13 shown are all situated at a first distance 31 with reference to lateral surface 21 of standardized sensor elements 11, 12 and 13. Because of the development of end extrusion coating 29, which surrounds standardized sensor elements 11, 12 and 13 in a bordering 41 at the upper part of the cylinder-shaped housing, the electrical connections between electrical terminals 17 and electrical conductors 25, which run in flex foil 23, or the corresponding areas of flat flexible cables (FFC), are encapsulated against damage and moisture.

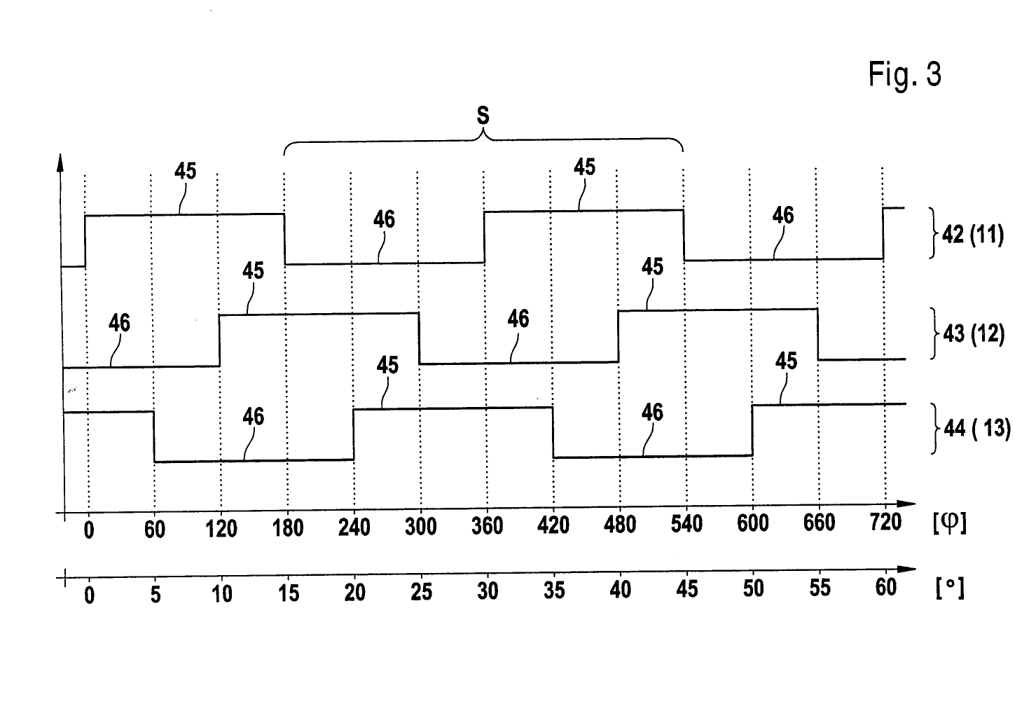

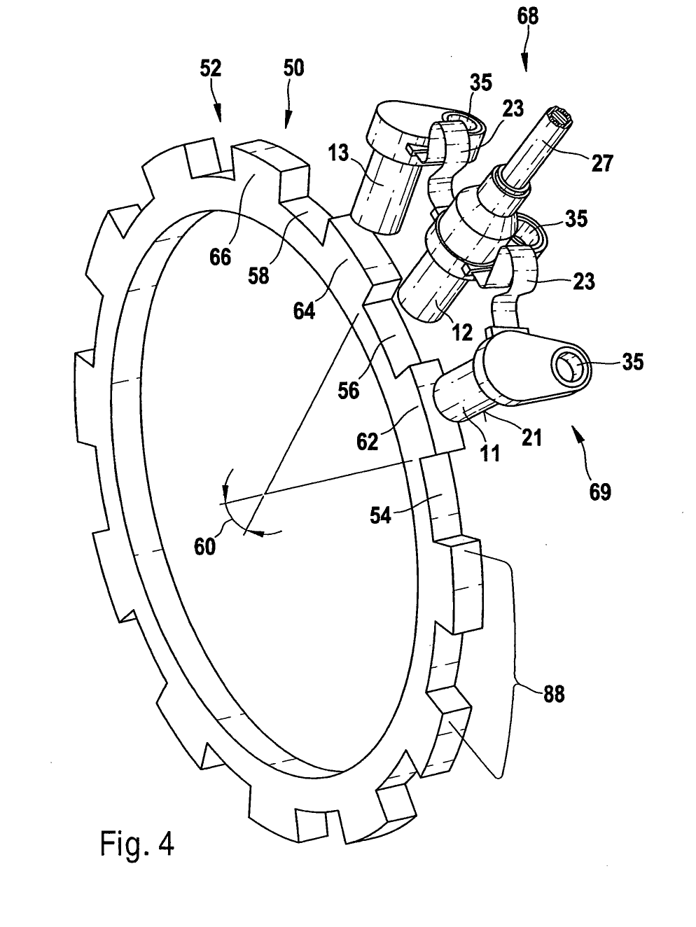

From the illustrations as in FIGS. 3 and 4, one may see a signal pattern of a digital signal during the rotation of a rotating body for the recording of an electrical angle and/or a mechanical angle.

FIG. 3 shows that three standardized sensor elements 11, 12 and 13 are situated offset with respect to their mechanical angle by respectively 10° mechanical angle. It may be seen from the signal pattern, shown in FIG. 3, during one rotation of a rotating body 50, such as a pulse-generating wheel, that first of all standardized sensor element 11 is passed, and last, third standardized sensor elements 13 is passed. In the illustration according to FIG. 3, a first signal pattern 42 of first standardized sensor element 11 is plotted, a second signal pattern 43 of second standardized sensor element 12 is plotted, and a third signal pattern 44 of third standardized sensor element 13 is plotted against electrical angle φ and the mechanical angle. Signal patterns 42, 43, 44 may be generated, for example, by a rotating body designed as a pulse-generating wheel of an electrical machine.

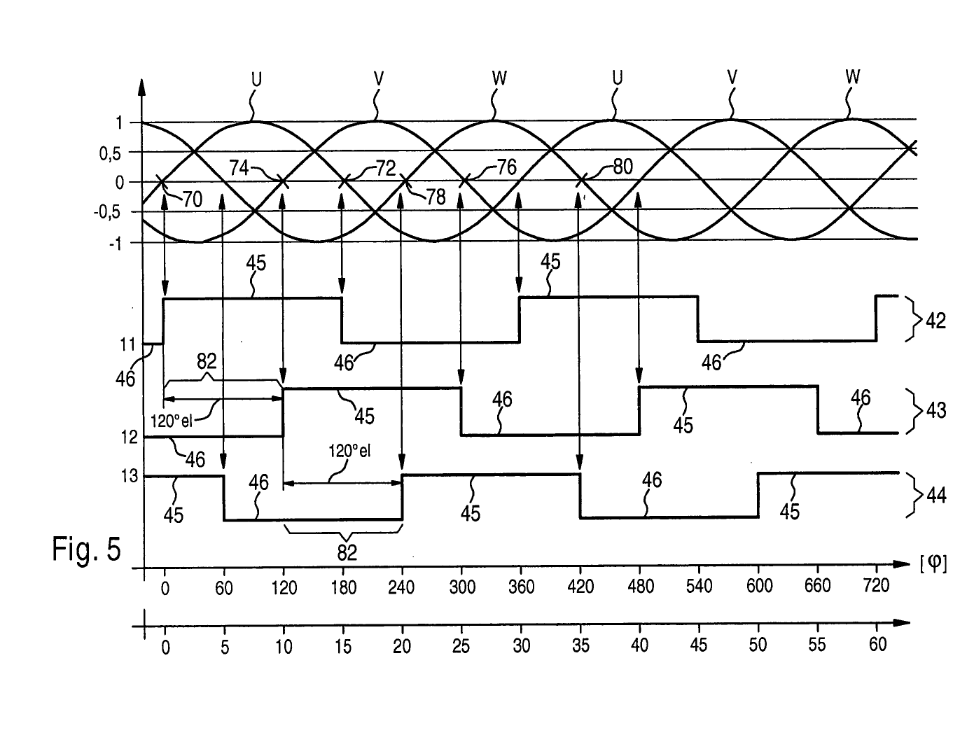

Sensor elements 11, 12 or 11, 12 and 13 that each scan rotating body 50, each pick up high signals 45 and low signals 46 generated by segment 88, that includes in each case one recess and one elevation. From the illustration of signal patterns 42, 43 and 44 according to FIG. 5, one may see that the respective initial edges of high condition 45, as seen in mechanical angles, lie one after the other by 10°.

Rotating body 50 according to FIG. 4 includes a number of equidistantly situated segments 88, n in number, in the case where a pulse-generating wheel is rotating body 50, n=2 p corresponds to the pole pairedness of an electrical machine. One may see from the system in FIG. 4 that a single track 52 is located at the outer circumference of rotating body 50. Single track 52 includes a first recess 54 which has a first elevation 62 downstream from it. First elevation 62 is followed by a second recess 56 which, on its part, has an elevation 64 downstream from it. Second elevation 64 is followed by a third recess 58 in single track 52, which has a third elevation 66 downstream from it. It may be seen from the illustration of FIG. 4 that recesses 54, 56, 58 and elevations 62, 64, 66 are scanned by a sensor system 69, which is situated in radial alignment 68 with respect to rotating body 50. Sensor system 69 shown in FIG. 4 includes the three standardized sensor elements 11, 12 and 13, which are connected to one another by flex foil 23 or flat flexible cables (FFC). On account of the short distance, flex foil 23 has been pushed together to form loops. Within single track 52, as seen in the circumferential direction, there is respectively one recess and one elevation, which together form a segment 88, situated in a division 60 of, for instance, 10°. Division 60 may of course also be developed in other numbers of degrees than 10°, as a function of the diameter of rotating body 50, as well as the accuracy with which the angular position, the rotational speed or the rotational position of rotating body 50 are to be recorded. If one segment or two segments are ordered offset to each other by 360°

$$\frac{electric}{2 p} \cdot n$$

(with n=1, 2, 3, 4, 5, . . . 12), which corresponds to a segment width S, which for 2 p=12 leads to an angular offset of 30°, the signal generated from this is equal to the one of the preceding position. In the case, for example, of a 12-pole paired electrical machine having a segment width S (division 60) of 30°, one possible arrangement lies approximately at 2×10° or 2×40°, etc. Furthermore, it is also possible to mount standardized sensor elements 11, 12 and 13 in a 20° arrangement. In this case, the output signal corresponds to the bit sequence in reverse travel. If standardized sensor elements 11, 12 and 13 of a sensor subassembly 69 are situated at a different mechanical angle with respect to rotating body that is to be scanned, it is easier to change the plug configuration. The connector pin assignment may also change, but the signal pattern remains the same.

Accordingly, possible mechanical arrangements of the standardized sensor elements are given by the angular positions 20°, 50°, 80° and 110°. Asymmetrical arrangements, as given, for example, by angular positions 10° or 40° also supply the same signal.

In the illustration according to FIG. 5, one may see a signal pattern in response to forward travel having the assignment of the individual phases of the electrical machine. From the signal patterns shown in connection with FIG. 3 for “forward travel” it may be seen that the respective starting signals of sensors B0 (11), B1 (12) and B2 (13) are offset from one another by 120° electrical. The signal sequence of the sensor signals is imaged as shown in the illustration as in FIG. 3, within at least one initial rotation of the at least one electrical machine. Accordingly, the signal sequence of the three standardized sensor modules B0 (11), B1 (12) and B2 (13), that are combined in a sensor system 69, for example, corresponds to phase voltages U, V and W of the electrical machine. That being the case, the individual sensor signals may be associated unequivocally with the respective phase voltages of phases U, V and W of the electrical machine as well as their zero crossings (compare illustration in FIG. 5).

The illustration in FIG. 5 shows in greater detail the signal patterns during forward travel having the association of phases U, V, W with the individual sensors B0 (11), B1 (12) and B2 (13). In the following we shall describe first signal pattern 42 of first standardized sensor element 11 (B0), starting from 0° mechanical angle. It may be seen in FIG. 5 that, as soon as the signal of first standardized sensor elements 11 (B0) has reached its high state 45, phase voltage U passes the zero crossing. At 15° mechanical and 180° electrical angle, when signal pattern 42 again reaches its zero crossing, signal pattern 42 of first standardized sensor elements 11 assumes its low state 46. In each case, phase shifted by 120° electrical and 10° mechanical, phase voltages V and W of the electrical machine follow signal patterns 43 of second standardized sensor element 12 (B1) or signal pattern 44 of third standardized sensor elements 13 (B2). The advantage of the method explained in exemplary fashion in connection with FIG. 5 may be seen in that a mechanical angle offset of the individual standardized sensor elements 11, 12 and 13, or rather B0, B1 and B2 is eliminated.

Using the method explained in exemplary fashion in connection with FIG. 5, it is also possible to control the electrical machine in optimum fashion, since there is no, or rather, substantially less, phase shift between phases U, V and W with respect to sensor signal patterns 42, 43 and 44 and the respective phase voltages. Because of the example method provided according to the present invention, three individual identical standardized sensor elements 11, 12 and 13 may be mounted, the assignment of the individual lines or outgoing cables 24 with these being a matter of choice. Both in case of a service call and also during first operation, the software is able to assign again newly installed sensor elements 11, 12 and 13, developed in a standardized fashion, to the corresponding ones of phases U, V and W.

1-8. (canceled)

9. A method for identifying a sensor assignment to output signals of an electrical machine having at least two standardized sensor elements that are assigned to a rotating body, the method comprising:
a) recording an arbitrary signal sequence of sensor signals of the at least two standardized sensor elements for a first direction of rotation of the electrical machine;
b) sorting the arbitrary signal sequence per sensor signal, with respect to an electrical angle of the electrical machine corresponding to an offset of an electrical angle φ and
c) assigning zero crossings of phases of the electrical machine to the sensor signals.

10. The method as recited in claim 9, wherein step b) includes ordering the sensor signals of the at least two standardized sensor elements with respect to an occurrence of a change in level from a low state to a high state over the electrical angle φ for a first direction of rotation.

11. The method as recited in claim 9, wherein step b) includes ordering the sensor signals of the at least two standardized sensor elements with respect to an occurrence of a change in level from a high state to a low state over the electrical angle φ for a first direction of rotation.

12. The method as recited in claim 10, wherein the occurrence of the change in level from the low state to the high state of the sensor signals is assigned to first zero crossings of the phases.

13. The method as recited in claim 12, wherein the occurrence of the change in level from the high state to the low state of the sensor signals is assigned to second zero crossings of the phases.

14. The method as recited in claim 9, wherein the offset of the electrical angle φ in step b) is 120°.

15. The method as recited in claim 9, wherein a standardized sensor element is assigned to each one of phases of the electrical machine, respectively.

16. The method as recited in claim 9, wherein step c) includes assigning the sensor signal patterns to the phases during initial rotations of the electrical machine.
